(19) United States
(12) Patent Application Publication
(10) Pub. No.: US 2003/0131226 A1
(43) Pub. Date: Jul. 10, 2003

(54) Dynamic distributed configuration management system

(76) Inventors: Donald J. Spencer, San Jose, CA (US); Dennis J. McMahon, Tracy, CA (US); Anthony J. Schaller, Alameda, CA (US)

Correspondence Address: FISH & RICHARDSON P.C., 500 ARGUELLO STREET, SUITE 500, REDWOOD CITY, CA, 94063, US

(21) Appl. No.: 10/039,619

(22) Filed: Jan. 4, 2002

(51) Int. Cl. G06F 1/24; G06F 3/00

(52) U.S. Cl. 713/100; 710/8

(57) ABSTRACT

Methods, apparatus, and systems, including computer program products, implementing and using techniques for updating a configuration of a device. An indication of an intended action to be performed by the device is obtained. A configuration list of program components required to perform the intended action is prepared based on the intended action and configuration information for the device. For each program component in the configuration list it is determined whether the program component is installed on the device. Each required program component that is not installed on the device is transferred to the device and the program component is installed on the device.

### BACKGROUND

This invention relates to downloading of software or firmware components through a communications network.

Software and firmware components have traditionally been sold or distributed to consumers through stores, mail-order companies, or various types of customer service organizations. When software and firmware components are distributed through these types of outlets, they are usually distributed on tangible media, such as compact discs, diskettes, or hard-ware circuitry or read-only memories embodying software instructions. A consumer typically inserts the tangible media containing the software or firmware component into the computer or device onto which the software or firmware component is to be installed and follows a series of installation and configuration instructions to get the software or firmware component properly installed.

Another way of distributing software and firmware components is to distribute the components over a communications network, such as the Internet. A consumer can connect to a software or firmware provider and download components over the Internet, either for free or for a fee. When the components have been downloaded to the consumer's computer, playback device, or pass-through device, the consumer typically follows a similar series of installation and configuration instructions to get the software or firmware component properly installed on the computer or device. In some cases, the installation process is partly automatic so that a user, after the component has been transferred to the user's computer, typically only enters a serial number for the component to be installed and agrees or declines to proceed with installation process. The automatic installation typically only works for one component at a time, though, and is generally independent of the device configuration.

In both of the above alternatives, the user needs to possess the skill to determine which components to download to his or her computer, where to obtain the components and how to install and configure the components. In some cases, a user may download several components that will have to be installed in a particular order, since some components may require the presence of others on the user's computer or device, such as subcomponents or components that work in conjunction with the one that is being installed. This can be problematic and frustrating for users (that is, consumers) who have limited knowledge about computers and other types of consumer electronic devices.

One example of an application that may need software or firmware component upgrades is an application for playing music or other types of media files that have been downloaded to a computer or a playback device. In the context of this application, the concept media file refers to a file that contains audio and/or video information. Media files exist in many different formats and usually a different software or firmware component or application program is needed to play each type of file. A few examples of conventional media file formats include MP3 files (Moving Picture Experts Group Layer-3 Audio files), WMA files (Windows Media Audio files), SAF files (Secure Audio File files), BMT files (Blue Matter Tracks) and RM files (Real Media files). Examples of common applications for playing media files include the RealPlayer and the Windows MediaPlayer software. Conventional playback devices usually only contain the necessary firmware or software for playing media files of the most widely available media formats.

When a new file format becomes available, or when a user would like to download a file of an existing format that is new to the user, the playback device or the computer merely informs the user about that the file cannot be played and that additional software or firmware components are needed. Often the user does not have the skill to know what software or firmware components are needed, where to find them, or how to install them. Alternatively, the user may have the skill but may not be willing to spend the time and energy necessary to find and install the missing software components. In both cases the result is that the user ends up with a more limited selection of media files that can be played on their computer or playback device, or with a botched installation where only a few components are properly installed.

A similar situation may occur based on what action a user tries to perform on some content, rather than based on the type of content. For example, a playback device or computer may have the necessary software or firmware components to play a downloaded audio file to a user, but the device or computer may not have the ability to transfer the content to another playback device without first downloading and installing further software or firmware components.

There are also systems that automatically inform a user about when updates to software and firmware components and are available. One such system is the Microsoft Windows Update system. In this system, a user navigates to a product update page in his or her web browser and selects to check for updates. A program component scans the user's system to see what components are installed, and compares the result of the scan with a list of available updates. Any components that do not exist on the user's system or for which updates are available are presented to the user in a list of downloadable options. The user selects which components he or she would like to install, and the components are downloaded and installed on the system. Even though a system like this facilitates installation of program components, the system is limited to a specific vendor and does not consider if the user tries to perform a specific action or not. It merely presents a list of available update options to the user.

### SUMMARY

In general, in one aspect, this invention provides methods, apparatus, and systems, including computer program products, implementing and using techniques for updating a configuration of a device. An indication of an intended action to be performed by the device is obtained. A configuration list of program components required to perform the intended action is prepared based on the intended action and configuration information for the device. For each program component in the configuration list it is determined whether the program component is installed on the device. Each required program component that is not installed on the device is transferred to the device and the program component is installed on the device.

Advantageous implementations can include one or more of the following features. Preparing a configuration list can include querying one or more databases based on the intended action and configuration information for the device. The intended action can be performed on one or more media files, each media file having an associated file type. The device can be a media playback device. The action can include one or more of playing at least one of the one or more media files, transferring at least one of the one or more media files to another device, transferring at least one of the one or more media files to a tangible medium, transferring at least one of the one or more media files to a network-based store, or configuring the device. The configuration list can be transferred to the device and determining whether the program component is installed on the device can be performed by a configuration manager located in the device.

Transferring each required program component can include using a configuration manager located in the device to request each required program component from one or more remote servers and to transfer each requested program component to the device. At least two remote servers can be hosted by different providers. The determining and transferring steps can be repeated after each installation of a program component on the device. The configuration list can include one or more software components. The configuration list can include one or more firmware components. The configuration list can include one or more minimum hardware component versions. The device can be a pass-through device. A list of program components that are installed on the device can be transferred to a remote system and it can be determined on the remote system whether each program component in the configuration list is installed on the device.

In general, in another aspect, this invention provides a configuration manager for updating a configuration of a device. The configuration manager includes means for obtaining an indication of an intended action to be performed by the device, means for determining whether the intended action can be performed by the device and means for updating the configuration of the device so that the intended action can be performed.

Advantageous implementations can include one or more of the following features. The means for determining can include means for receiving a configuration list of program components required to perform the intended action and means for determining for each program component in the configuration list whether the program component is installed on the device. The means for updating can include means for transferring each required program component that is not installed on the device to the device and means for installing the program component on the device. The means for transferring can include means for requesting each required program component from one or more remote servers and means for transferring each requested program component to the device. The device can be a pass-through device. The configuration manager can further include means for scheduling a configuration update.

In general, in another aspect, this invention provides an application server for updating a configuration of a device, including means for obtaining an indication of an intended action to be performed by the device, means for preparing a configuration list of program components required to perform the intended action, based on the intended action and configuration information for the device, and means for transferring the configuration list to the device.

Advantageous implementations can include one or more of the following features. The application server can further include means for transferring one or more required program components to the device. The application server can further include means for storing the configuration list. The application server can further include means for obtaining information about the file type. The file type can include one or more of codec type, codec version, digital rights management type, digital rights management version, encoded bit rate and rights associated with the media file. The means for preparing can include means for querying one or more databases based on information about an intended action to be performed on at least one media file by the device, information about the file type for the media file, and information about the device, and means for assembling result from database queries into a configuration list. The application server can further include means for obtaining information about the device. The configuration list can include one or more of program component name, program component version, registry check key, registry check value, file check location, file check version, file download size, file download URL, and file execution parameters.

In general, in another aspect, this invention provides methods, apparatus, and systems, including computer program products, implementing and using techniques for using a media device to perform an intended action on one or more media files. An indication of an intended action to be performed by the device is obtained. A configuration list of program components required to perform the intended action is prepared based on the intended action and configuration information for the device. It is determined for each program component in the configuration list whether the program component is installed on the device. Each required program component that is not installed on the device is transferred to the device and installed on the device. The intended action is performed on at least one of the one or more media files using the installed program components.

Advantageous implementations can include one or more of the following features. The steps of preparing, determining and transferring are performed without requiring any user interaction with the media device. At least one of the one or more media files can be transferred to the device.

The invention can be implemented to realize one or more of the following advantages.

A “goal-driven” configuration is created in which user does not need much knowledge to download and install components that are necessary to perform certain actions on certain types of files, such as playing media files. The configuration manager on the media playback device can keep a current list of installed components and file formats that can be played on the media playback device. If the user selects a media file format that cannot be played, the configuration manager works in conjunction with a remote system and automatically downloads and installs all the necessary components, before downloading the content itself. If the user selects the media file and wishes to perform an action on the media file that is not currently supported by the device, such as transferring the media file from one device to another device, the necessary components for performing this operation will automatically be downloaded and installed on the device prior to performing the action. A faster and less error-prone installation process with little or no user intervention can be achieved compared to when a user must manually find the necessary components, select the components, download the components to his or her playback device, and install the components. The installation process can iteratively discover if additional components are needed. If additional components are required, the process can automatically obtain and install the additional components in the correct order. Software and firmware components can be obtained from any server that is connected to the communications network and that gives a user permission to download and install components on his or her computer or playback device.

The details of one or more embodiments of the invention are set forth in the accompanying drawings and the description below. Other features, objects, and advantages of the invention will be apparent from the description and drawings, and from the claims.

### DETAILED DESCRIPTION OF DRAWINGS

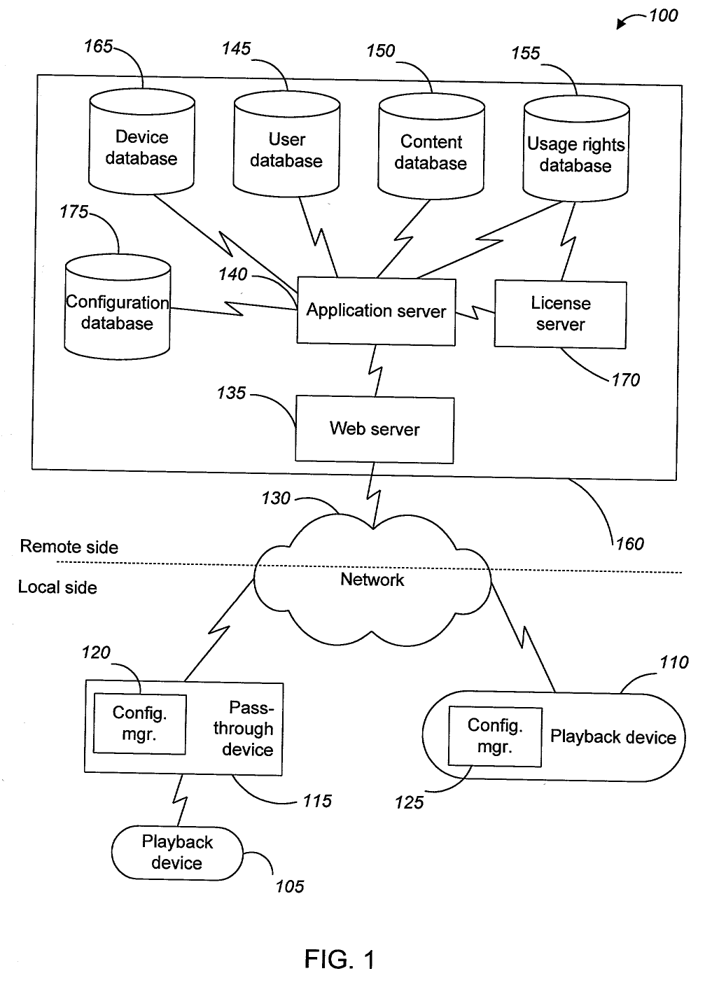

FIG. 1 is a schematic diagram showing a delivery system for media files in accordance with the invention.

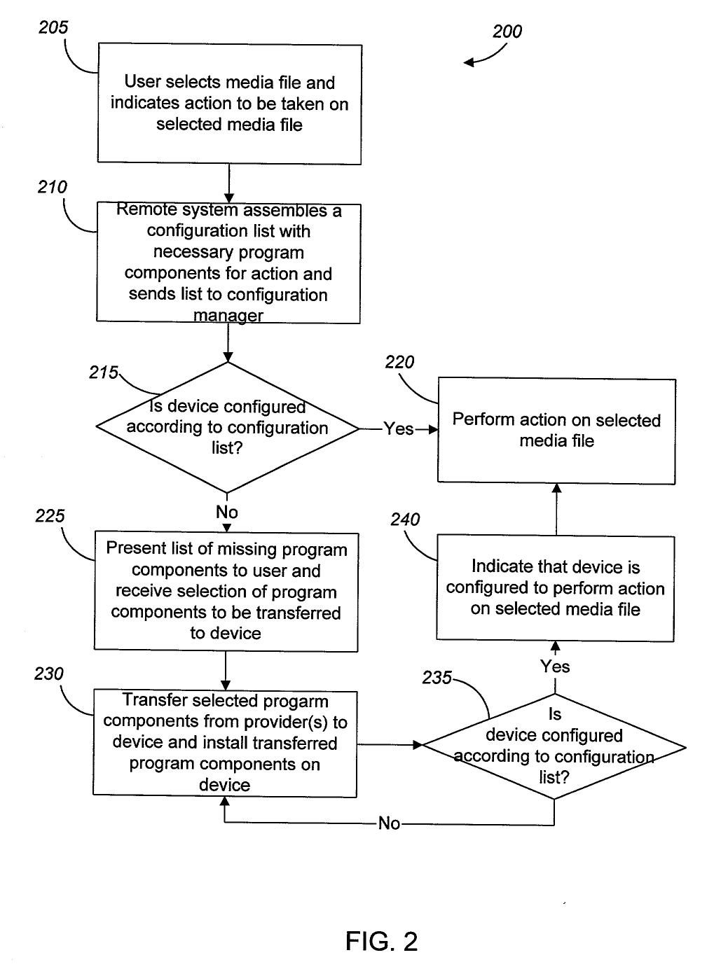

FIG. 2 is a flowchart showing a process for downloading and installing components necessary to perform a user-defined action on one or more selected media files.

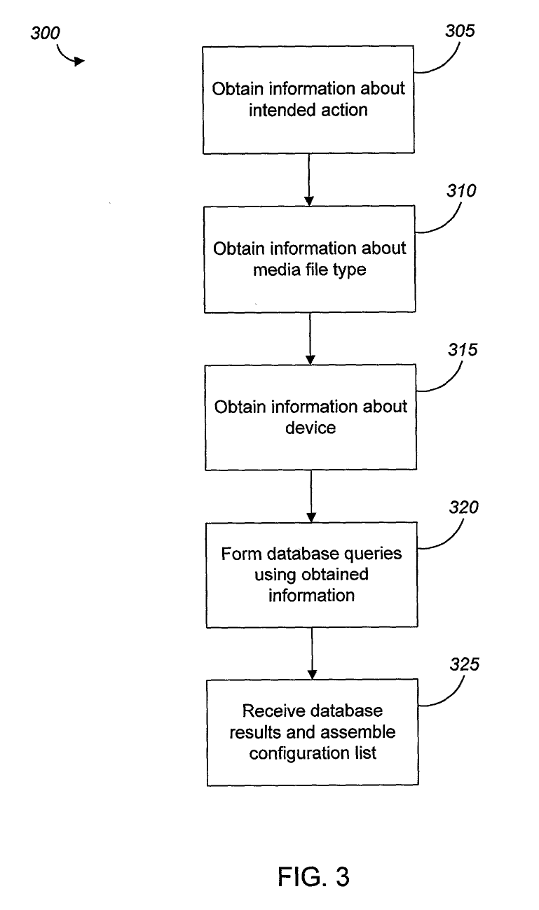

FIG. 3 is a flowchart showing a process for assembling a configuration list of components that are necessary to perform a user-defined action on one or more selected media files.

Like reference symbols in the various drawings indicate like elements.

### DETAILED DESCRIPTION

The invention will be described below by way of example software and firmware components, also referred to herein as program components, related to audio files and digital audio playback devices. A schematic view of a system for delivering audio files, software components and firmware components to a playback device in accordance with invention is shown in FIG. 1. A similar system, in which the invention also can be applied, is described in commonly-owned U.S. patent application Ser. No. 09/894,846, filed Jun. 27, 2001, which is hereby incorporated by reference in its entirety. As shown in FIG. 1, a system (100) for delivery of audio files, software components and firmware components to a particular device has a local side and a remote side. The concepts local side and remote side of the system are used here from a system user's (that is, a consumer's) point of view.

In one implementation of the system, the remote side includes a remote system (160) that interacts with users' playback devices during a delivery of audio files to those playback devices. The remote system (160) includes a web server (135), an application server (140), a user database (145), a content database (150), a device database (165), a license server (170) with an associated user rights database (155), and a configuration database (175). The different units of the remote system can be integrated into one or several physical units, depending on the needs of the service provider, and the physical units can be connected with conventional communication links. The devices at the local side of the system include devices that belong to users, such as a digital audio playback device (105,110) and optionally a pass-through device (115), such as a computer or set-top box, to which the user can connect an audio playback device. Optionally, the pass-through devices can have the functionality for playing audio files. A computer can, for example, be used both as a pass-through device and a playback device. It should also be noted that pass-through devices are not limited to set-top boxes and computers. Virtually any device that can connect to a remote system over a communications network such as the Internet and that has a port (for example, a USB port) to which a playback device can be connected can be used as a pass-through device.

Many other system configurations are possible, as will be clear from the following description. Furthermore, reference will be made throughout the specification to program components, that is, software and firmware components, related to audio files or to digital audio files, even though the techniques described here are applicable to any type of program components useful for performing a specific action on any media file that has content to be presented to a user, such as audio files, video files, and so on.

At the remote side of the system, the web server (135) provides a user interface between users connected to a communication network (130) and the application server (140), which is the central part of the remote system (160). The web server typically hosts web pages that are associated with a user interface and one or more services for selecting audio files to transfer from the server to a pass-through device (115) or playback device (105, 110) and web pages that are associated with the management of personal user accounts. A user can view the web pages, for example, in a web browser on his or her computer or on a display on a playback device, such as home stereo or a personal digital assistant (PDA). After identifying one or more desired audio files on the web pages, the user can request that those files be downloaded, such as by purchasing the audio files for unlimited playback on his or her playback device (105, 110) or by renting the audio files for a time limited period or a limited number of playbacks, or by receiving them for free as a promotional offer. The user can also indicate one or more actions that he or she wants to perform on the audio files that he or she has selected, such as playing an audio file to a user or transferring an audio file to a different playback device or to some type of tangible medium.

In one implementation, the web server (135) communicates with the application server (140). Any commands to the application server have to go through a configuration manager (120, 125) on the local side of the system and possibly through a web browser that is in communication with the web server (135) on the remote side of the system. Generally, as will be described below, a user will only need to provide simple commands to the application server, such as responding yes or no to various questions, selecting or deselecting program components in a list, and so on. Since these types of actions generally only require a simple user interface, a web interface is typically not necessary. Instead, a communication layer on the application server working in conjunction with a configuration manager on a playback device or pass-through device can provide a simpler user interface. The configuration manager (120, 125) will be described in further detail below. The application server acts as a coordinator for the remote system (160) and can communicate with the configuration managers (120,125) on the local side of the system, the web server (135), the user database (145), the content database (150), the device database (165), the license server (170) with its associated usage rights database (155), and the configuration database (175) on the remote side of the system. The user database (145) includes information about users and information relating to their digital media playback devices (105, 110), in particular, information associating particular devices with individual users. The content database (150) stores audio files and associated metadata. The device database (165) stores information about different types of audio playback devices (105, 110) and their capabilities, such as which types of audio files can be played on a given type of device. The usage rights database (155) stores information relating to usage rights for the audio files in the content database. The license server (170) receives requests for licenses from the application server (140) and issues licenses in response to the requests, based on information in its associated usage rights database (155). The configuration database (175) contains software and firmware components that may be required to play or otherwise perform actions on file formats not already supported on the user's playback device. Additionally, the configuration database (175) may contain links to other sources from which software and firmware components can be obtained. The configuration database (175) can be distributed, that is, all of it or parts of it can be physically located elsewhere, as long as it can be contacted over a communications network and permits an application server (140) to obtain software and firmware components that are to be delivered to a pass-through device (115) or a playback device (105, 110).

On the local side of the delivery system, a configuration manager (120, 125) is designed to communicate with the application server (140). The configuration manager (120, 125) can be located in a playback device (105, 110), or in a pass-through device (115). It should be noted that the pass-through device (115) generally also can function as a playback device. For reasons of simplicity, references will be made below to playback devices, but all such references should be considered to include pass-through devices having the same or similar capabilities as playback devices. The configuration manager (120, 125) contains the functionality required for receiving a list from the server of program components that are required by the playback device to perform a specific action requested by the user. The configuration manager can also detect currently installed software and firmware components on the playback device, compare the list of program components with the currently installed program components, request missing program components, and install the program components on the playback device after they have been received from a remote system. Optionally the configuration manager can also perform scheduling of program component downloads, for example, to schedule downloads for a particularly convenient time, and perform maintenance on installed software components, such as version upgrades, and so on. The functionality of the configuration manager will be described in further detail below. The configuration manager can be implemented in software or firmware, so that it can be implemented on devices with or without full operating systems.

In one implementation, the configuration manager is implemented as a module of a download manager, for example, as a set of C++ functions and methods that reside in the download manager. The download manager handles the communication with the remote system and, in addition to its usual function of obtaining licenses and audio files, is responsible for obtaining software and firmware components requested by the configuration manager module. The configuration manager itself determines a current device configuration and what additional program components are needed, and installs the additional program components that have been obtained by the download manager. The download manager's properties and methods are fully described in U.S. patent application Ser. No. 09/894,846. The download manager contains a web browser interface, inside which a browser specific core and a common core reside. The common core offers a common set of properties and methods that can be used by the browser specific program components. The common core also forms an interface to a media device manager (MDM) and a digital rights manager (DRM) that can reside on the playback device.

A process for downloading software or firmware components from the remote system (160) to a particular playback device (105, 110) and installing the program components on the playback device will now be described by way of example. It is assumed that a configuration manager, or a download manager including a configuration manager, for a playback device is connected to the communication network and that a user and the configuration manager have been identified to the remote system. The user who issues the request transfer of to his or her playback device can also have registered himself or herself and the playback device, or have connected the playback device to the network, so that the corresponding user information and device information exist in and can be retrieved from the user database and device database, respectively.

As shown in FIG. 2, a process (200) for downloading and installing software and/or firmware components starts when the user selects one or more media files and indicates an action to be taken on the one or more individual media files or one or more types of media files (205). The media files can exist on the playback device, on a pass-through device, or have to be transferred to the playback device or pass-through device from the remote system or some other place. A few examples of actions that can be taken on the files include playback, transfer of the files to another device, transfer of the files to a tangible storage medium, such as a compact disc, and so on. Furthermore, the user does not explicitly have to select each action that will be taken on the media files. The user can, for example, select to download media files to a playback device from a remote system. In this situation, it is reasonable to expect that the user also would like to play the media files in the near future, so the process can automatically expand the “download” action with a “play” action.

After the application server has received the user requests, a configuration component that runs on the application server assembles a configuration list that contains all the program components that are required or recommended to be present on the device in order to perform the intended action (210). The configuration list can additionally contain references to recommended locations where the required or recommended program components can be obtained. In one implementation, each type or class of audio file has one or more associated lists of program components that are required or recommended to be present in the device to perform a specific action on the media files. These lists are stored in the configuration database (175), which also may contain the program components or references to locations where the program components can be retrieved. The application server (140) uses the lists in the configuration database (175) to assemble the configuration list. An exemplary process for assembling a configuration list will be explained below with reference to FIG. 3. The assembled configuration list is then sent to the configuration manager, which is either located in the device or in a pass-through device that can communicate with the remote system on behalf of the device. In one implementation, the configuration list is obtained from a database in the form of an ASX-like (Active Streaming XML) file. An exemplary enhanced ASX file with a configuration list is shown in Table 1 below.

TABLE 1
<ASX Version = “3.0”>
<download entry>
<title>Example Download Item</title>
<param name=“AlbumID” value=“59458”/>
<param name=“AlbumName” value=“ Some Album Name”/>
<param name=“TrackName” value=“ Some Track Name”/>
<param name=“DownloadName” value=“Some Download Name.wma”/>
<param name =“DownloadURL”

value=“http://downloadserver.rioport.com/downloadpage.jhtml?gPid=35312?.../>

<param name=“GUID” value=“{6ABD2D11-42A0-11D5-AE30-0050DABD8213 }”/>
<param name=“LicensePullURL

value=“http://licenseserver.rioport.com/licensepage.jhtml?gPid=35312?.../>

<param name=“PostStatusURL”

value =“http://statusserver.rioport.com/statuspage.jhtml?gPid=353?.../>

<param name=“DRMTypet” value=“MSDRM” />
<param name=“ACTION” value=“DL_LIC” />
</download entry>
<RequiredSoftware>
<Item1>

<SoftwareNameID>12345</SoftwareNameID>
<SoftwareName>Configuration Installer</SoftwareName>
<Version>1.01 </Version>
<Size>1200</Size>
<SoftwareDownloadURL>http://server_name/ CfgManInstall.exe<SoftwareDownloadURL>
<FileCheck>

<FileName>CfgMan.dll</FileName>
<FileType>Win32 Driver</FileType>
<FileMinVersion>1.0.2.1 </FileMinVersion>

</FileCheck>

</Item1>
<Item2>

<SoftwareNamelD>12346</SoftwareNamelD>
<SoftwareName>Windows Media DRM</SoftwareName>
<Version>2.1.0</Version>
<Size>3255</Size>
<SoftwareDownloadURL>http://server_name/ WMDRMInstall.exe<SoftwareDownloadURL>
<RegistryCheck>

<ValueExists>HKLM\Software\DRM{cube root}WMDRM\IsInstalled=1</ValueExists>

</RegistryCheck>
<FileCheck>

<FileType>Win32 System</FileType>\
<FileName>WMDRM.dll</FileName>

</FileCheck>

</Item2>
</RequiredSoftware>
<RecommendedSoftware>
<Item1>

</SoftwareNameID>12348</SoftwareNameID>
<SoftwareName> Rioport Audio Manager, v3.5</SoftwareName>
<Version>3.5</Version>
<Size>7205</Size>
<SoftwareDownloadURL>http://server_name/RAMInstall.exe<SoftwareDownloadURL>
<RegistryCheck>

<ValueExists>HKLM\Software\RioPort\RAM\RAMInstalled=1</ValueExists>

</RegistryCheck>
<FileCheck>

<FileName>RAM.exe</FileName>
<FilePath>%PROGRAM%\Rioport</FilePath>
<FileType>Program</FileType>
<MinFileVersion>3.5.0.3</MinFileVersion>

</FileCheck>

</Item1>
<Item2>

</SoftwareNameID>12347</SoftwareNameID>
<SoftwareName>Windows Media Player, v7.0</SoftwareName>
<Version>7.0<Version>
<Size>9700</Size>
<SoftwareDownloadURL>http://server_name/ WMPInstall.exe<SoftwareDownloadURL>
<FileCheck>

<FileName>WMP.exe</FileName>
<FilePath>%PROGRAM%\Microsoft\WindowsMedia</FilePath>
<FileType>Program</FileType>
<MinFileVersion>3.5.0.3</MinFileVersion>

</FileCheck>

</Item2>
</RecommendedSoftware>
</ASX>

The file shown in Table 1 contains information necessary to download the track “Some Track Name” from the album “Some Album Name.” The first section of the file, between the download entry tags, refers to data related to the track and information necessary for downloading the track. The album “Some Album Name” is identified in the service provider's database by an AlbumID value, 59458. The track is represented by a file and identified by a file name “Some Download Name.wma,” where the extension .wma indicates that the file format is a windows media file. The file can be obtained from the DownloadURL “http://downloadserver.rioport.com/downloadpage.jhtml?gPid=35312? . . . ” The “GUID” parameter with the value {6ABD2D11-42A0-11D5-AE30-0050DABD8213} represents an identifier for the file “Some Download Name.wma.” The LicensePullURL parameter identifies a URL http://licenseserver.rioport.com/licensepagejhtml?gPid=35312? . . . that points to a license server where a license can be obtained for the song “Some Track Name.” The parameter “PostStatusURL” with the value http://statusserver.rioport.com/statuspage.jhtml?gPid=353? . . . represents a link to a page on which the download status is posted. Finally, the last parameters in the download entry section, DRMType and ACTION, shows that the usage rights are controlled by the Microsoft Digital Rights Management system (MSDRM) and that a Download License (DL_LIC) is required.

After this information, which all relates to the track, a section of information follows that relates to the software that needs to be installed on the device in order for the device to be able to download the track. There are two required items, Item 1 and Item 2, that are each defined by a number of parameters. The first required item, Item 1, is a Configuration Installer, version 1.01, with the SoftwareNameID 12345 and a size of 1200 kB. The parameter SoftwareDownloadURL indicates that the software component can be obtained from the URL http://server_name/CfgManInstall.exe. The FileCheck section lists information about the required file, such as the file name “CfgMan.dll,” the file type “Win32 Driver,” and the FileMinVersion “1.0.2.1,” which indicates to the configuration manager that version 1.0.2.1 or later of the .dll file needs to be present on the device. If the configuration manager determines that an older version is present, or that the .dll file is missing on the device, an upgrade is needed. The second required item, Item 2, is is a Windows Media DRM, version 2.1.0, with the SoftwareNameID 12346 and a size of 3255 kB. The parameter SoftwareDownloadURL indicates that the software component can be obtained from the URL http://server_name/WMDRMInstall.exe. In addition to the FileCheck section that lists information about the required file, such as the file name “WMDRM.dll,” and the file type “Win32 System,” there is a RegistryCheck section that contains instructions for checking for certain values that, for example, represent installed program components, in a registry database on the device. In the present example, the ASX file contains an instruction to check if the parameter HKLM\Software\DRM\WMDRM\IsInstalled=1 exists in the registry database.

After the section listing the required software, there is a section that lists software that is recommended. This section is organized in the same way as the section detailing the required software above, and will therefore not be described further here. The recommended software is a Rioport Audio Manager and a Windows Media Player. This recommended software is presented as optional to the user, so the user has to confirm whether or he wants to download any of the recommended software components.

Additional program components can be added to this configuration list, if necessary, and the list can look different depending on which media file the user has selected or which action he or she tries to perform.

After receiving the configuration list, the configuration manager on the device determines whether each required or recommended program component in the configuration list exists on the device so that the device can perform the intended action (215). If the device has all the required program components, the process performs the intended action on the selected media file (220) when desired.

If the device is not properly configured, the configuration manager presents a list of the missing program components, or program components whose version is older than the acceptable version, to the user and receives a user selection of program components to be transferred to the device (225). The list of missing program components is based on the configuration list sent out from the remote system and contains the requested and recommended program components for the device and the type of action. When the user has made a selection of program components in the missing program component list, the selected program components are transferred to the configuration manager from the remote system or from the various locations provided in the configuration list (230). The configuration manager installs the transferred program components on the device after the program components have been received according to instructions that are included in the configuration list that was received by the configuration manager in step 210. The instructions include, for example, in what order the program components should be installed. Alternatively, the program components can be temporarily stored on the device and the installation can be initiated by a user at a different time. After the program components have been installed, the process checks again if the device is configured according to the configuration list (235). If the device is properly configured, the process indicates to the user that the device is configured to perform the action on the selected media file (240) and continues to step 220, where it performs the desired action when appropriate, and otherwise the process returns to step 230 where it continues to transfer the selected program components, as described above.

In many cases, the downloaded program components come with their own associated installers, so the primary role of the configuration manager is to supervise the overall installation process and delegate the installation of the respective program components to their individual installers. If an installer that is associated with a program component requires additional sub-components to be installed, this installer will manage the retrieval and installation of the sub-components without any interaction of the configuration manager. The configuration manager does not intervene until the program component has been installed, and the next program component in the configuration list should be installed.

An exemplary process (300) for assembling a configuration list will now be explained with reference to FIG. 3. In one implementation, the configuration list can be created by a configuration agent running on the application server. The configuration agent works in conjunction with the configuration database, which contains information pertaining to installing and configuring software/firmware components based on specific intended action(s) to be performed on a type (or class) of media files by a particular target device. For example, a WMDRM_V1.2 component is required for the intent to TRANSFER a media file of type SECURE_WMA to a PC DESKTOP running WINDOWS 2000.

The process carried out by the server-based configuration agent obtains the information to create the configuration list. More particularly, first, information about the action intended by the user is obtained (305). As was described above, examples of intended actions include transfer, playback, burn to CD, create copy, refresh license (count or time based expiration).

After information about the intended action has been obtained, the process obtains information about the media file type (310). The media file type describes a class or category of media file and can include information such as CODEC (COder-DECoder) and version, DRM and version, encoded bit rate, and associated rights and rules.

The last type of information to be obtained is the intended target, which describes the type of target device and the associated operating environment (315). The information about the intended target may include information such as target type (that is, PC, portable device, consumer electronics device, and so on), hardware platform and version, operating system and version, and firmware version.

The server-side configuration agent then aggregates the obtained information described above (320) to form database queries that will return information pertinent to required software components and installation/configuration instructions. This information is formed into a configuration list (325), which is arranged into a format that can be used by the client-side configuration manager, such as the ASX format described above. The list is then sent to the requesting device on the client side, where it is used by the client-side configuration manager to detect the presence and status of installed program components, and to perform the necessary installation and configuration steps, as was described above. As was described above, the following list illustrates the information typically contained in a configuration list entry (or record), although many different configurations are possible: component name, component version, registry check key/value (specific to target platform), file check location (specific to target platform), file check version, file download size, file download URL, and file execution parameters. The example described with reference to FIG. 3 only illustrates one exemplary implementation of the invention. In other implementations, the information about the media file type, intended action and the device can be obtained in any arbitrary order without affecting the way the database queries are performed, for example.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention.

For example, the techniques described herein can be implemented in a system using any means of communication with a remote device, and is not limited to a conventional web server interface. The techniques are not dependent on any particular type of connection or communication protocol between the remote system and the configuration manager as long as data can be transferred from one place to another.

A user does not have to download software components and media files at the same time. For example, if the user wishes to prepare a playback device for a media file that he or she knows will be downloaded in the future, he or she can instruct the remote system to check if the playback device has the right configuration for the upcoming download. If the playback device is not correctly configured, he can choose to download the missing program components and install them so that the media file alone can be downloaded at a later time.

The configuration manager can optionally report back to the remote system or create a local log after the downloaded program components have been installed. The state of the device before and after each installation of a program component can be verified, so that it can be determined whether the installation was successful or should be performed again. Certain functions that are performed by the configuration manager in the implementations described above can be performed by the remote system in order to achieve an optimal load balance between the local side and the remote side of the system. For example, the configuration manager does not have to compare the configuration list with the device configuration on the device. Instead, the configuration manager can generate a device configuration list and send that list to the server, to be compared with the configuration required for performing the user action on the selected media file. The remote system can also provide more detailed instructions to the configuration manager than what has been described above.

The installation of a program component can trigger a new check for certain program components and the assembly of a new configuration list, depending on the configuration of the device. This check can be done automatically or be optional, that is, requiring that a user confirms that the check should be performed. The check can be performed by the configuration manager, and the new configuration list can be performed by the configuration agent on the application server, in a manner similar to the creation of the original configuration list.

The configuration list does not have to be an ASX file, but any type of data structure that can initiate communication between a configuration manager and a server to discover that firmware or software program components loaded for the intended action on the device need to be installed or updated, or that the hardware version needs to be changed.

The invention has been described above for audio files in particular, but is also applicable to other types of media files, such as video files, and corresponding media playback devices for playing back files of this type. The invention is also applicable to any type of media files and software or firmware components that may be necessary to make the media file available to a user. For example, a web browser may need additional software or firmware components in order to display the content of a particular media file on a web page to a user, a computer game software may need additional software or firmware components to be expanded from a single user environment to a multi-user environment, and so on. These program components can be downloaded with little or no user interaction, using the configuration manager in accordance with the application. A playback device may need specific program components to be able to communicate with a proprietary back end or network-based store. Accordingly, other embodiments are within the scope of the following claim.

What is claimed is:

1. A method for updating a configuration of a device, comprising:
obtaining an indication of an intended action to be performed by the device;
preparing a configuration list of program components required to perform the intended action based on the intended action and configuration information for the device;
determining for each program component in the configuration list whether the program component is installed on the device; and
transferring each required program component that is not installed on the device to the device and installing the program component on the device.

2. The method of claim 1, wherein preparing a configuration list comprises querying one or more databases based on the intended action and configuration information for the device.

3. The method of claim 1, wherein the intended action is to be performed on one or more media files, each media file having an associated file type.

4. The method of claim 3, wherein the device is a media playback device.

5. The method of claim 3, wherein the action includes one or more of:
playing at least one of the one or more media files, transferring at least one of the one or more media files to another device, transferring at least one of the one or more media files to a tangible medium, transferring at least one of the one or more media files to a network-based store, or configuring the device.

6. The method of claim 1, further comprising:
transferring the configuration list to the device;
wherein determining whether the program component is installed on the device is performed by a configuration manager located in the device.

7. The method of claim 1, wherein transferring each required program component comprises:
using a configuration manager located in the device to request each required program component from one or more remote servers and to transfer each requested program component to the device.

8. The method of claim 7, wherein at least two remote servers are hosted by different providers.

9. The method of claim 1, further comprising:
repeating the determining and transferring steps after each installation of a program component on the device.

10. The method of claim 1, wherein the configuration list comprises one or more software components.

11. The method of claim 1, wherein the configuration list comprises one or more firmware components.

12. The method of claim 1, wherein the configuration list comprises one or more minimum hardware component versions.

13. The method of claim 1, wherein the device is a pass-through device.

14. The method of claim 1, further comprising:
transferring a list of program components that are installed on the device to a remote system; and
determining on the remote system whether each program component in the configuration list is installed on the device.

15. A configuration manager for updating a configuration of a device, comprising:
means for obtaining an indication of an intended action to be performed by the device;
means for determining whether the intended action can be performed by the device; and
means for updating the configuration of the device so that the intended action can be performed.

16. The configuration manager of claim 15, wherein the means for determining comprises:
means for receiving a configuration list of program components required to perform the intended action; and
means for determining for each program component in the configuration list whether the program component is installed on the device.

17. The configuration manager of claim 15, wherein the means for updating comprises:
means for transferring each required program component that is not installed on the device to the device; and
means for installing the program component on the device.

18. The configuration manager of claim 17, wherein the means for transferring comprises:
means for requesting each required program component from one or more remote servers; and
means for transferring each requested program component to the device.

19. The configuration manager of claim 15, wherein the configuration list comprises one or more software components.

20. The configuration manager of claim 15, wherein the configuration list comprises one or more firmware components.

21. The configuration manager of claim 20, wherein the configuration list comprises one or more hardware component versions.

22. The configuration manager of claim 16, wherein the device is a pass-through device.

23. The configuration manager of claim 16, further comprising means for scheduling a configuration update.

24. The configuration manager of claim 16, wherein the intended action is to be performed on one or more media files, each media file having an associated file type.

25. The configuration manager of claim 24, wherein the device is a media playback device.

26. The configuration manager of claim 24, wherein the action includes one or more of:
playing at least one of the one or more media files, transferring at least one of the one or more media files to another device, or transferring at least one of the one or more media files to a tangible medium.

27. An application server for updating a configuration of a device, comprising:
means for obtaining an indication of an intended action to be performed by the device;
means for preparing a configuration list of program components required to perform the intended action, based on the intended action and configuration information for the device; and
means for transferring the configuration list to the device.

28. The application server of claim 27, further comprising means for transferring one or more required program components to the device.

29. The application server of claim 27, further comprising means for storing the configuration list.

30. The application server of claim 27, wherein the action is to be performed on one or more media files, each media file having an associated file type.

31. The application server of claim 30, further comprising means for obtaining information about the file type.

32. The application server of claim 30, wherein the file type includes one or more of codec type, codec version, digital rights management type, digital rights management version, encoded bit rate and rights associated with the media file.

33. The application server of claim 30, wherein the means for preparing comprises:
means for querying one or more databases based on information about an intended action to be performed on at least one media file by the device, information about the file type for the media file, and information about the device; and
means for assembling result from database queries into a configuration list.

34. The application server of claim 27, further comprising means for obtaining information about the device.

35. The application server of claim 27, wherein the device is a pass-through device.

36. The application server of claim 27, wherein the device is a media playback device.

37. The application server of claim 27, wherein the configuration list includes one or more of the following:
program component name, program component version, registry check key, registry check value, file check location, file check version, file download size, file download URL, and file execution parameters.

38. A method for using a media device to perform an intended action on one or more media files, comprising:
obtaining an indication of an intended action to be performed by the device;
preparing a configuration list of program components required to perform the intended action based on the intended action and configuration information for the device;
determining for each program component in the configuration list whether the program component is installed on the device;
transferring each required program component that is not installed on the device to the device and installing the program component on the device; and
performing the intended action on at least one of the one or more media files using the installed program components.

39. The method of claim 38, wherein the steps of preparing, determining and transferring are performed without requiring any user interaction with the media device.

40. The method of claim 38, further comprising transferring at least one of the one or more media files to the device.
